(19) United States
(12) Patent Application Publication
(10) Pub. No.: US 2022/0332982 A1
(43) Pub. Date: Oct. 20, 2022

(54) Mat Stickers for Yoga and Pilates

(71) Applicant: Eleanor Amy Ayscue, Brooklyn, NY (US)

(72) Inventor: Eleanor Amy Ayscue, Brooklyn, NY (US)

(21) Appl. No.: 17/232,178

(22) Filed: Apr. 16, 2021

(51) Int. Cl. C09J 7/38; A63B 21/00; C09J 7/25; G09F 3/02

(52) U.S. Cl. CPC C09J 7/385; A63B 21/4037; C09J 7/25; G09F 3/02; A63B 2209/00; C09J 2483/006; C09J 2433/00; G09F 2003/023; G09F 2003/0266

(57) ABSTRACT

The present invention is stickers for exercise mats, such as those commonly used in yoga or pilates. These mat stickers are available in a multitude of geometric shapes and adhere to the mats via an acrylic surface. A preferred thickness for the mat stickers is approximately 1.5 mm, which provides a sufficient grip for the practitioner, but is thin enough to roll into the mat at the conclusion of the exercise.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### CROSS REFERENCE TO RELATED APPLICATION

None.

### FIELD

The present invention relates to devices to assist practitioners and pilates from slipping off their mats during their yoga exercises.

### BACKGROUND OF THE INVENTION

Exercise mats are smooth and slippery. Practitioners have trouble holding poses because the mat surface doesn't prevent their hands and feet from slipping. Yoga mats are smooth with a consistent surface gradient, with nothing to adhere to with hands and feet. When yoga practitioners get sweaty from practice there's nothing to stop them from slipping. A slippery yoga mat makes a yoga practice frustrating and ineffective. Hands and feet slide, poses are difficult to hold and concentration is ruined.

Yoga mats alone are inadequate to prevent sliding due to the evenness of their surface. The slick surface provides little texture. Non-slip towels add bulk and weight to a rolled mat, making them awkward to transport. They also must be thoroughly washed on a regular basis to remove sweat.

U.S. D548,951 (Paulin) discloses a sock for pilates, yoga, or exercise.

U.S. D674,226 (Greenwald) disclosed a yoga mat cover.

U.S. Pat. No. 7,107,626 (Andrews) discloses a sock for mat-based exercises, such as yoga or pilates. The sock has five toe holes in the front end with webbing extending between the toe holes from the top of the sock to the bottom or sole of the sock to provide these openings through which the toes of a user can extend. The sock also has a layer of a PVC vinyl material on the bottom or sole of the sock which has a sticky or friction characteristic to enable the sock to grip a floor or mat when used by an exerciser, with or without the use of a mat, and to allow the toes to be exposed for tack or gripping functions.

U.S. Pat. No. 7,156,791 (Edwards) discloses yoga grip blocks having one or more block sections and a grip section that provide support and comfort in the practice of yoga exercises.

U.S. Pat. No. 8,220,076 (Chen) discloses a yoga glove that has a palm section, a back section, and a finger section.

U.S. Pat. No. 9,066,546 (Getzwiller) discloses hand and foot yoga garments with enhanced positional stability and comfort. These include garment wraps, one each for the hand and the foot, each including opposite, external-surface-contact, and external-surface-non-contact side structures extending between open front and rear ends, and elastomeric, inter-digit, motion-and-escape-restraining straps, or a single strap, spanning the wrap's open front end, and interconnecting, the wrap's two side structures.

U.S. Pat. No. 9,463,348 (Connaughton) discloses a yoga mat with support and traction. In particular, it discloses a layered structure including a top layer, a bottom layer, and a grip component disposed between the two layers such that columns from the grip component extend at least partially through openings in the top layer and/or bottom layer.

U.S. Pat. No. 9,814,926 (Izzolo) a resilient hand pad and block system for relieving hand and wrist stress, and related pain, during yoga and related floor-based poses and exercises. In particular, it discloses a hand pad for stabilizing and supporting on a floor or other surface the hand of a user during either stationary/static or dynamic exercises includes a hand pad body having a top surface defining a debossed profile of a human hand, or human hand-shaped cavity, for receiving therein a hand of a user.

U.S. Pat. No. 10,213,640 (St. Jeor) discloses an anatomical yoga hand grip and trainer for relieving wrist strain.

U.S. Pat. No. 10,383,380 (Koven) discloses an athletic strap includes a glove portion including a plantar aspect, a dorsal aspect, and a cavity defined between the plantar and dorsal aspects. A similar invention was disclosed in US Published Patent Application No. 2017/0020212 (Koven).

U.S. Pat. No. 10,953,272 (Pelosi) discloses a device adapted to adhere to a yoga mat comprises a body comprising a convex portion and a planar portion, and an adhesive element on the planar portion for adhering the body to the yoga mat.

US Published Patent Application No. 2016/0030799 (Sutherland) discloses a rubber or foam type yoga mat whose top surface is formed with lateral ridges or swells running continuously from one side of the mat to the other to provide consistent, easily-cleaned traction for hands and feet without the need for a sticky surface material.

US Published Patent Application No. 2020/0329782 (Kim) discloses a cushion-padded sock in which a cushion pad is attached through mold pressing to adjust the thickness of the cushion pad.

The present invention overcomes the drawbacks in the prior art.

### SUMMARY OF THE INVENTION

A mat sticker comprising:
a geometric pattern of a material body;
an adhesive surface; and,
wherein the material body is attached to an exercise mat through the means of the adhesive surface.

The geometric pattern of [0020] wherein it is a hexagonal pattern.

The geometric pattern of [0021] wherein the hexagonal pattern is honeycomb.

The geometric pattern of [0021] wherein the hexagonal pattern is trimeric.

The geometric pattern of [0020] wherein it is a rectangular pattern.

The geometric pattern of [0020] wherein it is a leaf-shape pattern.

The material body of [0020] wherein it is silicone.

The material body of [0026] wherein the silicone is 70 shore A durometer.

The material body of [0020] wherein it is cork.

The adhesive surface of [0020] wherein it is an acrylic adhesive.

The adhesive surface of [0029] wherein the acrylic adhesive is a double-surface tape.

The material body of [0020] wherein it has a thickness of 1.5 mm.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 displays the trimeric hexagonal shape variant according to the present invention.

FIG. 2 displays the honeycomb hexagonal pattern variant according to the present invention.

FIG. 3 displays the leaf-shape variant according to the present invention.

FIG. 4 displays the rectangle-shape variant according to the present invention.

### DETAILED DESCRIPTION OF THE PREFERRED EMBODIMENTS

For a more complete understanding of the present invention, the objects and advantages thereof, reference is now made to the ensuing descriptions.

The present invention consists of mat stickers for practitioners of yoga and pilates to avoid slipping on the mat. These mat stickers adhere to the mat surface with the use of an acrylic adhesive. This provides a grip for both hands and feet to brace against. This prevents the hands and feet from slipping on the mat and in turn, facilitates the strengthening of the muscles of the arms and legs.

The mat sticker creates a slightly raised surface of approximately 1.5 mm. For the practitioner, this subtle change in the surface level of the mat enables the practitioner's hands and feet to “claw” at the mat and grip better. This improves the practitioner's pose and stability.

The mat sticker attaches to the mat via an acrylic adhesive which creates a semi-permanent fixture for multiple uses of the product with the mat. The mat sticker can be removed once attached, but this destroys the adhesive and a new coating of adhesive would need to be applied before the mat sticker can attach again to a mat.

In a preferred embodiment, the mat sticker is furbished to the practitioner with the adhesive already applied, but covered in a non-adhesive backing for shipment. The practitioner then removes the non-adhesive backing from the mat sticker before attaching to the surface of a mat. The user then has hand and foot traction on the mat.

In a preferred embodiment, the mat sticker has small bumps or studs that cover the top surface. This creates extra texture and decreases hand and foot slippage.

As an advantage of the invention, the applied mat stickers can be rolled with a standard mat for yoga and pilates.

As a further advantage of the invention, the mat stickers made from silicone are naturally anti-microbial and need only be quickly wiped down for cleaning.

As another advantage of the invention, the mat stickers can be placed on any other athletic equipment to enhance the grip and traction to avoid slips. This could be a yoga block, a staircase, or anywhere else the practitioner desires.

Construction

The use of silicone 70 shore A durometer (70A) is preferred. A softer silicone would peel off the mat and a firmer silicone would not roll with the mat.

In a preferred embodiment, the silicone is molded or die cut into a 1.5 mm thick shape.

Another variant of the present invention utilizes cork instead of silicone. The dimensions of the cork variant are the same as that of silicone.

A pressure-sensitive adhesive is applied to the under surface of the mat sticker. In a preferred embodiment, this is a commercially available acrylic adhesive. In an especially preferred embodiment, the acrylic adhesive is a double coated tissue tape such as 9448A and sold by 3M.

### Examples

The invention employs any number of potential shapes and geometric patterns.

These geometric patterns include circles, diamonds, ovals, rectangles, squares, stars, pentagons, hexagons, heptagons, octagons, and the like.

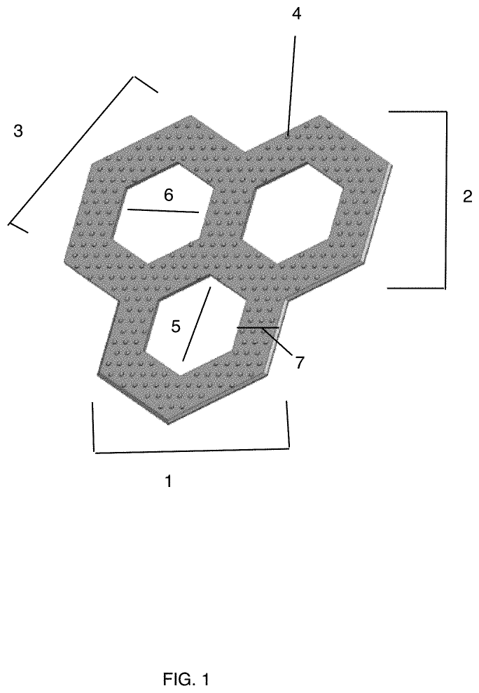

Non-limiting examples of potential shapes are described in reference to FIGS. 1-4. In a preferred embodiment, each is approximately 1.5 mm in thickness when attached to a mat.

Reference is made to FIG. 1, which displays the trimeric hexagonal shape according to the present invention. The trimeric hexagonal shape comprises three interconnected hexagons, as demonstrated by Item (1), Item (2), and Item (3). Item (4) designates a series of studs on the upper surface of the trimeric hexagonal shape.

Item (5) designates the length of the internal hexagonal lumen. In a preferred embodiment, it is 1.9 inches long.

Item (6) designates the width of the internal hexagonal lumen. In a preferred embodiment, it is 1.64 inches wide.

Item (7) designates the width of the body of a hexagonal piece. In a preferred embodiment, it is 0.75 inches wide.

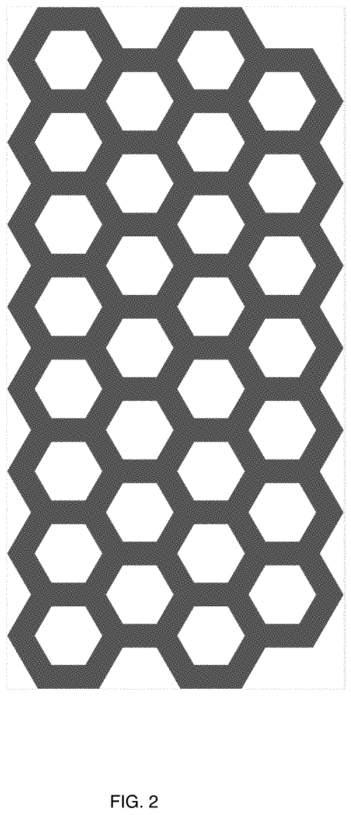

Reference is made to FIG. 2, which displays the honeycomb hexagonal pattern according to the present invention. In a preferred embodiment, the dimensions of the individual hexagons of the honeycomb pattern are the same as that of the trimeric hexagon. Specifically, the internal hexagonal lumens are 1.9 inches long and 1.64 inches wide, and the width of the body of a hexagonal piece is 0.75 inches wide.

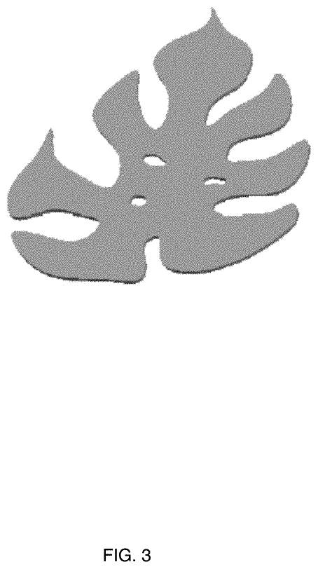

FIG. 3 displays the leaf-shape variant according to the present invention.

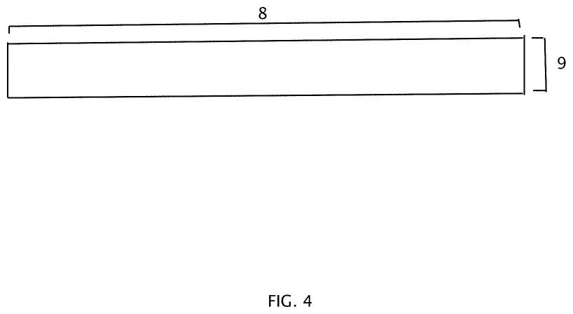

Reference is made to FIG. 4, which displays the rectangular-shape according to the present invention. Item (8) designates the length of the rectangle. In a preferred embodiment, this side is 22 inches long. Item (9) designates the width of the rectangle. In a preferred embodiment, this side is one inch long

Some detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

The invention may be embodied in other specific forms without departing from the spirit of essential characteristics thereof. The present embodiments therefore to be considered in all respects as illustrative and not restrictive, the scope of the invention being indicated by the appended claims rather than by the foregoing description, and all changes which come within the meaning and range of equivalency of the claims are therefore intended to be embraced therein.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The foregoing description comprises illustrative embodiments of the present invention.

As will be appreciated, the foregoing objects and examples are exemplary and embodiments need not meet all or any of the foregoing objects, and need not include all or any of the exemplary features described herein. Additional aspects and embodiments within the scope of the claims will be devised by those having skill in the art based on the teachings set forth herein.

While the invention has been described in connection with what are considered to be exemplary embodiments, it is to be understood that the invention is not limited to the disclosed embodiments, but on the contrary, is intended to cover various modifications and equivalent arrangements included within the spirit and scope of the appended claims.

I claim:

1. A mat sticker comprising:
a geometric pattern of a material body;
an adhesive surface; and,
wherein the material body is attached to an exercise mat through the means of the adhesive surface.

2. The geometric pattern of claim 1 wherein it is a hexagonal pattern.

3. The geometric pattern of claim 2 wherein the hexagonal pattern is honeycomb.

4. The geometric pattern of claim 2 wherein the hexagonal pattern is trimeric.

5. The geometric pattern of claim 1 wherein it is a rectangular pattern.

6. The geometric pattern of claim 1 wherein it is a leaf-shape pattern.

7. The material body of claim 1 wherein it is silicone.

8. The material body of claim 8 wherein the silicone is 70 shore A durometer.

9. The material body of claim 1 wherein it is cork.

10. The adhesive surface of claim 1 wherein it is an acrylic adhesive.

11. The adhesive surface of claim 10 wherein the acrylic adhesive is a double-surface tape.

12. The material body of claim 1 wherein it has a thickness of 1.5 mm.
